(19) United States
(12) Patent Application Publication
(10) Pub. No.: US 2016/0140105 A1
(43) Pub. Date: May 19, 2016

(54) INFORMATION EXTRACTION FROM SEMANTIC DATA

(71) Applicant: Empire Technology Development LLC, Wilmington, DE (US)

(72) Inventors: Jun FANG, Xi'an, Shaanxi (CN); Daqi LI, Xi'an, Shaanxi (CN)

(21) Appl. No.: 14/374,144

(22) PCT Filed: Jul. 31, 2013
(86) PCT No.: PCT/CN2013/080461

§ 371 Date: Jan. 29, 2016

(51) Int. Cl. G06F 17/27; G06F 17/30

(52) U.S. Cl. CPC G06F 17/2725; G06F 17/30876; G06F 17/271

(57) ABSTRACT

Technologies and implementations for extracting information from semantic data available, for example, on the World Wide Web, are generally disclosed.

### BACKGROUND

Unless otherwise indicated herein, the approaches described in this section are not prior art to the claims in this application and are not admitted to be prior art by inclusion in this section.

Large amounts of semantic data may be accessible from a computer. For example, large amounts of semantic data may be available on the World Wide Web (WWW). Due to the potentially vast amounts of semantic data, extracting information from the semantic data (e.g., using computers, or the like) may be difficult.

### SUMMARY

Described herein are various illustrative methods for extracting information from semantic data on the World Wide Web. Example methods may include generating a plurality of assertions from an ontology corresponding to the semantic data based at least in part on a plurality of statements of the ontology, determining information candidates based at least in part on syntax of information representation language, and validating the information candidates based at least in part on the plurality of assertions.

The present disclosure also describes various example machine readable non-transitory medium having stored therein instructions that, when executed by one or more processors, operatively enable a semantic data processing module to generate a plurality of assertions from an ontology corresponding to the semantic data based at least in part on a terminological box (Tbox) classification and an assertion box (Abox) sampling, determine information candidates based at least in part on syntax of information representation language, and validate the information candidates based at least in part on plurality of assertions.

The present disclosure additionally describes example systems. Example systems may include a processor, and a semantic data processing module communicatively coupled to the processor, the semantic data processing module configured to generate a plurality of assertions from an ontology corresponding to the semantic data based at least in part on a terminological box (Tbox) classification and an assertion box (Abox) sampling, determine information candidates based at least in part on syntax of information representation language, and validate the information candidates based at least in part on plurality of assertions.

The foregoing summary is illustrative only and not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Subject matter is particularly pointed out and distinctly claimed in the concluding portion of the specification. The foregoing and other features of the present disclosure will become more fully apparent from the following description and appended claims, taken in conjunction with the accompanying drawings. Understanding that these drawings depict only several embodiments in accordance with the disclosure, and are therefore, not to be considered limiting of its scope. The disclosure will be described with additional specificity and detail through use of the accompanying drawings.

In the drawings:

FIG. 1 illustrates a block diagram of a system configured to extract information from semantic data on the WWW;

FIG. 2 is a flow chart of an example method for extracting information from semantic data on the WWW;

FIG. 3 illustrates an example computer program product; and

FIG. 4 illustrates a block diagram of an example computing device, all arranged in accordance with at least some embodiments described herein.

### DETAILED DESCRIPTION

The following description sets forth various examples along with specific details to provide a thorough understanding of claimed subject matter. It will be understood by those skilled in the art that claimed subject matter might be practiced without some or more of the specific details disclosed herein. Further, in some circumstances, well-known methods, procedures, systems, components and/or circuits have not been described in detail, in order to avoid unnecessarily obscuring claimed subject matter.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

This disclosure is drawn, inter alia, to methods, devices, systems and computer readable media related to information extraction from semantic data.

Large amounts of semantic data may be available (e.g., on the WWW, on a LAN, in a data center, on a server, or the like). The available semantic data may correspond to a variety of different subjects (e.g., science, history, sports, economics, society, technology, etc.). Due to the large amounts of semantic data that may be available, extracting information (e.g., patterns, statistics, inferences, potentially useful facts, etc.) from the semantic data may be difficult. For example, large amounts of semantic data related to cancer may be available on the WWW. Extracting information (e.g., possible cause of cancer, etc.) from the semantic data may be difficult.

Additionally, some techniques for extracting information from data stored in a database may not be applicable to extracting information from semantic data. More particularly, as data stored in a database may have a different format than semantic data (e.g., relational vs. graph based, etc.,) techniques for extracting information from data stored in a database may not be applicable to extracting information from semantic data.

In general, semantic data may be organized based at least in part on a terminological box (Tbox) classification and an assertion box (Abox) sampling. In general, a TBox classification may define relationships among concepts and/or roles within the semantic data. An ABox sampling may describe information about one or more entities, using the concepts and roles defined by the TBox. As an example, semantic data may correspond to patients in a hospital. Such semantic data may have a TBox classification that describes the concept “hospital patient.” The semantic data may also have an ABox sampling that describes any number of entities (e.g., persons, animals, or the like) that are “hospital patients.”

Various embodiments described herein may be provided for extracting information from semantic data. In some examples, information may be extracted from semantic data by generating assertions from the semantic data, determining information candidates from the semantic data, and applying a verification process on the determined information candidates using the generated assertions. Some examples presented herein may describe extracting information from semantic data available on the WWW. However, this is not intended to be limiting. For example, information may be extracted from semantic data available in a data center, on a LAN, on a server, or the like.

In some examples, a computing device, coupled to the Internet, may be configured to both generate assertions and determine information candidates from semantic data available on the WWW. The computing device may further be configured to validate the determined information candidates based at least in part on the generated assertions.

The computing device may generate a multiple number of assertions from an ontology corresponding to the semantic data based at least in part on the TBox classification and/or the ABox sampling. In some embodiments, the computing device may generate assertions by assigning entities referenced in the ABox sampling to a concept and/or role from the TBox classification (e.g., based on a concept hierarchy tree and/or based on a role hierarchy tree). Alternatively and/or additionally, the computing device may generate assertions by identifying patterns (e.g., used by a majority of assertions in the ABox sampling, or the like) in the ABox sampling.

The computing device may determine information candidates based at least in part on a “simplicity rule”. For example, information candidates may be restricted to a particular length. In some examples, the length may be based on the syntax of information representation language. The computing device may determine information candidates based at least in part on a “novelty rule”. For example, information candidates may be required to be “new” (e.g., not already described by the TBox, or the like).

The computing device may validate the determined information candidates based at least in part on the generated assertions. In some embodiments, the computing device may validate the information candidates based at least in part on a “majority rule”. For example, the computing device may determine information candidates that satisfy a majority or the generated assertions.

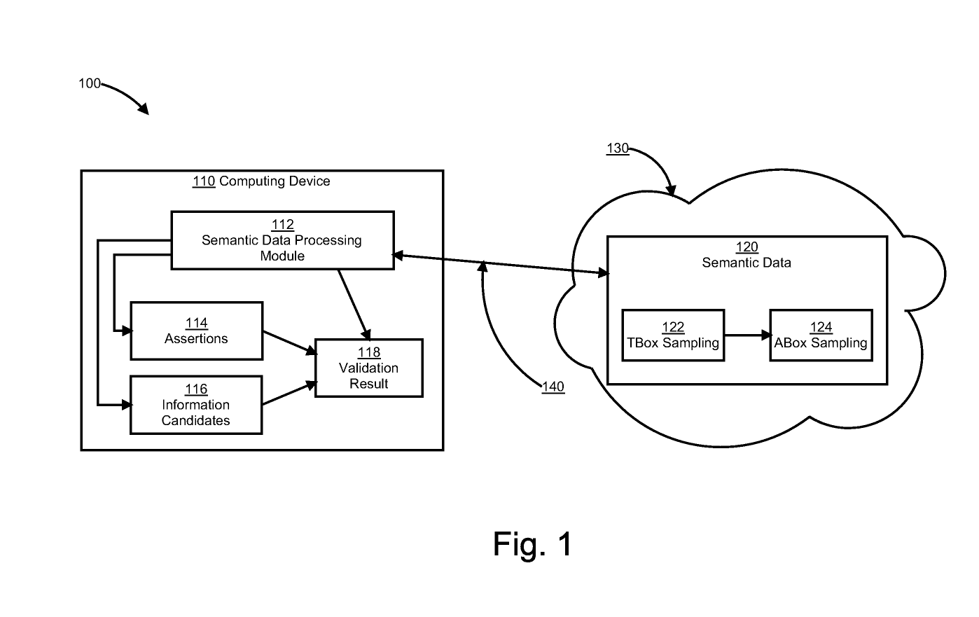

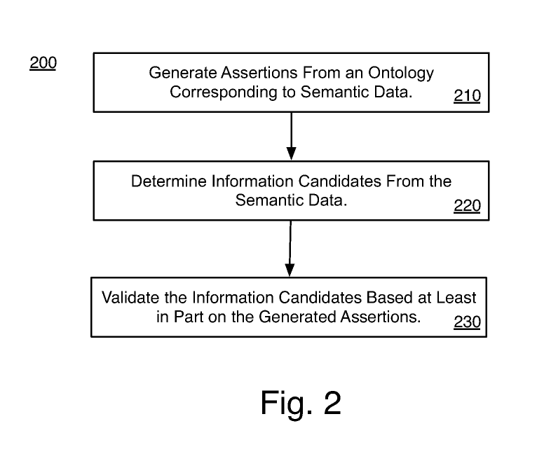

FIG. 1 illustrates an example system 100 configured to extract information from semantic data on the WWW, arranged in accordance with at least some embodiments described herein. As depicted, the system 100 may include a computing device 110 configured to extract information from semantic data on the WWW. In general, the computing device 110 may be configured to generate assertions and determine information candidates from some semantic data on the WWW. For example, the computing device 110 may be configured to generate assertions and determine information candidates from some semantic data related to one or more causes of cancer that may be available on the WWW. The computing device 110 may further be configured to validate the determined information candidates based at least in part on the generated assertions. More details and examples of the computing device 110 generating assertions from semantic data will be provided below while discussing FIG. 1 and FIG. 2, as well as elsewhere herein.

As depicted in this figure, the computing device 110 may access semantic data 120 available on the WWW 130 via connection 140. In some embodiments, the computing device 110 may access an amount of semantic data 120 sufficient for computing device 110 to generate assertions and determine information candidates as described herein. The computing device 110 may be any type of computing device connectable to the Internet. For example, the computing device 110 may be a laptop, a desktop, a server, a virtual machine, a cloud computing system, a distributed computing system, and/or the like. The connection 140 may be any type of connection to the Internet. For example, the connection 140 may be a wired connection, a wireless connection, a cellular data connection, and/or the like.

The semantic data 120 may be any ontology describing entities and the entities' relationship to a concept and/or a role using a TBox classification 122 and an ABox sampling 124. The TBox classification 122 may include sentences describing concept hierarchies (e.g., relationships between concepts) and/or role hierarchies (e.g., relationships between roles). The ABox sampling 124 may include sentences stating where in the hierarchy one or more entities belong (e.g., relationships between entities and the concepts).

TBox classification and ABox sampling facilitates or allows for the determination of an approximate ABox, since calculation of the complete ABox (derivation of all implicit assertions) may be difficult, especially for a very large semantic data set. On the other hand, more implicit assertions allows for or correlates to more accurate ABox sampling wherein derivation of all implicit assertions may be desired. Optimally, a balance point may be found between derivation of all implicit assertions and a sufficiently large number of implicit assertions obtained to achieve a desired ABox sampling accuracy. Since TBox classification is efficient and some implicit assertions can be easily obtained, TBox classification for the original ABox is executed before the ABox sampling, meaning that TBox classification may be replaced by other efficient methods. One purpose of TBox classification is to make the sequent ABox sampling process more accurate, i.e., to capture important patterns based on more assertions. Furthermore, computed assertions (ABox1) before ABox sampling can also be used to generate a combined set of assertions, e.g., ABox1∪ABox2.

The semantic data 120 may be expressed using any suitable language. For example, the semantic data 120 may be expressed using the Resource Description Framework (RDF), the Web Ontology Language (OWL), Extensible Markup Language (XML), or the like. Similarly, the semantic data 120 may be expressed using a variety of description logics (e.g., SHOIN, SHIF, SROIQ, or the like).

The computing device 110 may include a semantic data processing module 112. In general, the semantic data processing module 112 may be configured to extract information from the semantic data 120 as described herein. Simply stated, the semantic data processing module 120 may be configured to generate assertions 114 and determine information candidates 116 from the semantic data 120. The semantic data processing module 112 may further be configured to validate the determined information candidates 116 based at least in part on the generated assertions 114.

In general, the generated assertions 114 may include multiple assertions. Similarly, the determined information candidates 116 may include multiple information candidates. In some portions of the present disclosure, the generated assertions 114 and the determined information candidates 116 are referred to in the plural form. As such, the “set” of generated assertions 114 or the “set” of determined information candidates 116 may be referenced. Additionally, in some portions of the present disclosure, a single one of the generated assertions 114 or a single one of the determined information candidates 116 is referred to. Although care is taken to distinguish between plural and singular references, it is to be appreciated, that in some references to the plural form, the singular form may be implied and vice versa.

The semantic data processing module 112 may determine the assertions 114 based on at least in part on the TBox classification 122 and/or the ABox sampling 124. For example, the semantic data processing module 112 may generate assertions by assigning entities referenced in the original ABox in the TBox classification algorithm to a concept and/or role from the TBox classification 122 (e.g., based on a concept hierarchy tree and/or based on a role hierarchy tree). As another example, the semantic data processing module 112 may generate assertions by identifying patterns (e.g., used by a majority of assertions in the ABox sampling 124, or the like) in the ABox sampling 124.

The semantic data processing module 112 may generate information candidates 116 based on at least in part on restricting the determined information candidates to a particular length (e.g., based on syntax of information representation language, or the like). As another example, the semantic data processing module 112 may require determined information candidates 116 to be “new” (e.g., not already described by the TBox, or the like).

The semantic data processing module 112 may validate the determined information candidates 116 based at least in part on the determined assertions 114. In response to, or a part of the validation, the semantic data processing module 112 may generate a validation result 118. In some examples, the determined information candidates 116 that satisfy a majority of the generated assertions 114 may be included in the validation result 118.

FIG. 2 illustrates a flow diagram of an example method for extracting information from semantic data on the WWW, arranged in accordance with at least some embodiments described herein. In some portions of the description, illustrative implementations of the method are described with reference to elements of the system 100 depicted in FIG. 1. However, the described embodiments are not limited to these depictions. More specifically, some elements depicted in FIG. 1 may be omitted from some implementations of the methods detailed herein. Furthermore, other elements not depicted in FIG. 1 may be used to implement example methods detailed herein.

Additionally, FIG. 2 employs block diagrams to illustrate the example methods detailed therein. These block diagrams may set out various functional blocks or actions that may be described as processing steps, functional operations, events and/or acts, etc., and may be performed by hardware, software, and/or firmware. Numerous alternatives to the functional blocks detailed may be practiced in various implementations. For example, intervening actions not shown in the figures and/or additional actions not shown in the figures may be employed and/or some of the actions shown in the figures may be eliminated. In some examples, the actions shown in one figure may be operated using techniques discussed with respect to another figure. Additionally, in some examples, the actions shown in these figures may be operated using parallel processing techniques. The above described, and other not described, rearrangements, substitutions, changes, modifications, etc., may be made without departing from the scope of claimed subject matter.

FIG. 2 illustrates an example method 200 for extracting information from semantic data on the WWW. Beginning at block 210 (“Generate Assertions From an Ontology Corresponding to Semantic Data”), the semantic data processing module 112 may include logic and/or features to generate assertions from semantic data on the WWW. In general, at block 210, the semantic data processing module 112 may generate the assertions 114 from the semantic data 120.

In some examples, the semantic data processing module 112 may, at block 210, generate assertions 114 by assigning entities referenced in the original ABox in the TBox classification algorithm to a concept and/or role from the TBox classification 122 (e.g., based on a concept hierarchy tree and/or based on a role hierarchy tree). Alternatively, and/or additionally, the semantic data processing module 112 may, at block 210, generate assertions 114 by identifying patterns (e.g., used by a majority of assertions in the ABox sampling 124, or the like) in the ABox sampling 124.

For example, the semantic data processing module 112 may, at block 210, determine a concept hierarchy tree and/or a role hierarchy tree based in part on the roles and/or concepts defined in the TBox classification 122. The semantic data processing module 112 may assign entities references in the original ABox in the TBox classification algorithm to concepts and/or roles in the determined hierarchy trees. The following pseudo code is provided as an illustrative example for how the semantic data processing module 112 may generate assertions 114 from semantic data 120.

```
    FUNCTION: Generate Assertions From Semantic Data (O) 120.
    INPUT: TBox classification 122 and the original ABox.
    OUTPUT: A New ABox (ABox1) That Includes One or More
Generated Assertions.
    Start
        Process the TBox classification 122 to generate a concepts
    hierarchy tree (T1) and role hierarchy tree (T2).
        For each concept assertion C(a) in the ABox 124
          Generate an assertion D(a) by assigning entity a to an all
    super-concept (D) that corresponds to C in the T1.
          Add the assertion D(a) to ABox1.
        End For
        For each role assertion R(b,c) in the ABox 124
          Generate an assertion S(b,c) by assigning entities b and c to
    an all super-role (S) that corresponds to R in T1.
          Add the assertion S(b,c) to ABox1.
        End For
    End
```

As another example, the semantic data processing module 112 may, at block 210, identify assertion patterns that are used by more than a threshold number of assertions in the ABox sampling 124. For example, the semantic data processing module 112 may determine the number of entities in the ABox sampling 124 (where a1, a2-an represents entities in the ABox sampling 124) that use a particular pattern (where C(x) represents a pattern). The semantic data processing module 112 may determine if the number of entities using the pattern C(x) exceeds a threshold value, and if so, generate an assertion based on the pattern. Assuming that the semantic data processing module 112 determines that a number of entities in the ABox sampling 124 greater than the threshold number use the pattern C(x), the semantic data processing module 124 may generate an assertion C(a_{new}) based on the identified pattern C. For example, assume there are 1000 patients in the hospital, and 306 patients feel good about the services of the hospital, denoted by feelGood (pᵢ, hospitalServices), where pᵢ is a patient. Assuming the threshold is 30%, the pattern feelGood (pᵢ, hospitalServices) is selected. All feelGood (pᵢ, hospitalServices) assertions may then be removed from the ABox, and a feelGood (p_{new}, hospitalServices) may be added into the ABox. In the meantime, the mapping relation between p_{new} and pᵢ is recorded. In some examples, the threshold number may correspond to a number equal to or greater than a majority (e.g., 50%, or the like) of the entities referenced in the ABox sampling 124. The following pseudo code is provided as an illustrative example of how the semantic data processing module 112 may generate assertions 124 from semantic data 120.

```
    FUNCTION: Generate Assertions from Semantic Data (O) 120.
    INPUT: Concepts Hierarchy Tree (T1), Role Hierarchy Tree (T2),
TBox classification 122, ABox sampling 124, and a Threshold Number
Representing Majority Rule (d).
    OUTPUT: A New ABox Sampling (ABox2) That Includes One or
More Generated Assertions.
    Start
    n = 1
    1.  Process the TBox classification 122 to identify all n-dimensional
    patterns based on the concepts and the roles in the TBox classification
    122.
    For each identified pattern
        Determine the number of assertions (x) that satisfy the pattern.
        If x > d, Then
            Add the pattern into a new ABox sampling (ABox3) and
        the relationship between the pattern and the represented
        assertions into a mapping table M.
        End If
    End For
    If at least one pattern satisfied the majority rule Then
        n++.
        go back to step 1.
    Else
    Determine all assertions based on T1, T2, and ABox3.
    (Comment: In the above operation, algorithms are used to find
implicit assertions that cannot be computed by the TBox classification
(assertions in ABox1))
    Generate corresponding assertions using M.
    Add all generated assertions to ABox2.
    END
```

In some examples, one or more of the patterns in the ABox sampling 124 may be multi-dimensional (e.g., contain more than one axiom, or the like). For example, the pattern C(x) may be a one-dimensional pattern while the pattern C1(x), C2(x) may be a two-dimensional pattern. As shown in the above pseudo code, multi-dimensional patterns may be incrementally explored, until no patterns of that dimensionality satisfy the majority rule. In some examples, assertions from leaf concepts and/or leaf roles may be directly assigned to its super concepts and/or roles.

As stated above, in some examples, the semantic data processing module 112 may generate the assertions 114 using a variety of different approaches. For example, the generated assertions in ABox1 and ABox2 may be combined (e.g., ABox1∪ABox2, or the like) to form the set of generated assertions 114.

Continuing from block 210 to block 220 (“Determine Information Candidates From the Semantic Data”), the semantic data processing module 112 may include logic and/or features to determine information candidates. In general, at block 220, the semantic data processing module 112 may be configured to determine the information candidates 116 from the semantic data 120. For example, the semantic data processing module 112 may determine the information candidates 116 based on the syntax of information representation language corresponding to the semantic data 120. The semantic data processing module 112 may determine the information candidates 116 by limiting the length of the determined candidates based in part on a simplicity rule. Alternatively, and/or additionally, the semantic data processing module 112 may determine information candidates based in part on the TBox classification 122 (e.g., using a novelty rule, or the like). For example, the semantic data processing module 112 may remove any information candidates from the generated information candidates 116, which are already described and/or implied by the TBox classification 122.

In some examples, the semantic data processing module 112 may determine information candidates IC={I1, I2 . . . } using the following rules, where {C, . . . } is a set of concepts and {R, . . . } a set of roles from the TBox classification 122 and n is a non-negative integer. It is noted, that the following rules are expressed using SHOIN description logic and OWL, which is not intended to be in any way limiting.

Concepts construction rule: C→ [symbol] C|C1 [symbol] C2|C1␣C2|∃RC|∀RC|≧nR|≦nR|

Role construction rule: Trans(R), R₁ [symbol] R₂, R⁻,

In some examples, the length of an information candidate may be restricted to a length L, which may be determined based in part on the following equations, which also use SHOIN description logic and OWL.

|D|=1, for a concept (D)

| [symbol] C|=|C|+1

|C1 [symbol] C2|=|C1␣C2|=|C1|+|C2|+1

|∃RC|=|∀RC|=|C|+2

|≧nR|≦nR|=n+1

|Trans(R)|=2

|R₁ [symbol] R₂|=3

R⁻=2

Continuing from block 220 to block 230 (“Validate the Information Candidates Based at Least in Part on the Generated Assertions”), the semantic data processing module 112 may include logic and/or features to validate the determined information candidates. In general, at block 230, the semantic data processing module 112 may validate the determined information candidates 116 based at least in part on the generated assertions 114 (e.g., ABox1, and/or ABox2, or the like). The semantic data processing module 112 may provide the validated information candidates 116 as the validation result 118.

In some examples, the semantic data processing module 112 may, at block 230, validate the determined information candidates 116 based in part on the syntax of information representation language corresponding to the semantic data 120. As an illustrative example of the syntax of an information representation language, Table 1 is provided. Table 1, shown below, depicts some example syntaxes and semantics based on the SHOIN description logic.

TABLE 1

| Syntax | Semantics |
|---|---|
| T | ^{Δ}^{^{I}} |
| ⊥ | Ø |
| [symbol] C | ^{Δ}^{^{I}}^{\C}^{^{I}} |
| C1 [symbol] C2 | C₁^{I} ∩ C₂^{I} |
| C1 [symbol] C2 | C₁^{I} ∪ C₂^{I} |
| ∃r.C | {d εΔ^{^{I}} \| there is an e εΔ_{^{I}} with (d,e) ε r^{I} and e ε C^{I}} |
| ∀r.C | {d ε Δ_{^{I}} \| for all e ε Δ_{^{I}}, (d,e) ε r^{I} implies e ε C^{I} } |
| ≦ nR.C | ∀y₁,. . ., yₙ₊₁ : [symbol] R(x, yᵢ) \hat{ } [symbol] C(yᵢ) → [symbol] yᵢ ≈ yⱼ |
| ≧ nR.C | ∃y₁,. . ., yₙ₊₁ : [symbol] R(x, yᵢ) \hat{ } [symbol] C(yᵢ) \hat{ } [symbol] yᵢ [symbol] yⱼ |
| R₁ [symbol] R₂ | ∀x,y : \hat{ }R₁(x,y) → R₂ (x,y) |
| Trans (R) | ∀x,y,z : R(x,y) \hat{ } R(y,z) → R(x,z) |
| R⁻ | ∀x,y : R(x, y) [symbol] R⁻ (y,x) |

The semantic data processing module 112 may validate the determined information candidates 116 based in part on determining a degree of certainty for each of the information candidates in the set of information candidates 116. For example, assume all entities in the original ABox sampling 124 correspond to the domain Δ¹. The semantic data processing module 112 may, at block 230, determine a degree of certainty for an information candidate (ICₖ) based in part on the following equations, where IC_{c} is a concept information candidate and ICᵣ is a role information candidate.

$$certainty ( I {C}_{c} ) = \frac{number of assertions which satisfy {IC}_{c} in ABox 1 ⋃ ABox 2}{\vert {Δ}^{I} \vert}$$

$$certainty ( I {C}_{r} ) = \frac{number of assertions which satisfy {IC}_{r} in ABox 1 ⋃ ABox 2}{\vert {Δ}^{I} \times {Δ}^{I} \vert}$$

In some examples, the semantic data processing module 112 may, at block 230, determine if the certainty of an information candidate is greater than a threshold value. The semantic data processing module 112 may add the information candidate to the validation result 118 based on the determination that the certainty of the information candidate is greater than a threshold level.

In some embodiments, the semantic data processing module 112 may, at block 230, determine whether a selected information candidate (ICᵢ) models another selected information candidate (ICⱼ) (e.g., ICᵢ|=ICⱼ). In some examples, if the semantic data processing module 112 determines that ICᵢ|=ICⱼ, the selected information candidates may be validated based on the following formula.

certainty (ICⱼ)>ζ [symbol] certainty (ICᵢ)>ζ

certainty (ICᵢ)<ζ [symbol] certainty (ICⱼ)<ζ

Accordingly, the semantic data processing module 112 may, at block 230, determine that the certainty of an information candidate (ICᵢ) exceed the threshold value if the certainty of its implied information candidate (ICⱼ)) exceeds the threshold value. In which case, the semantic data processing module 112 may add the selected concept information candidate (ICᵢ) to the validated results 118. Similarly, the semantic data processing module 112 may, at block 230, determine that the certainty of an information candidate (ICⱼ) does not exceed the threshold value if the certainty of the selected concept information candidate (ICᵢ) does not exceed the threshold value. In which case, the semantic data processing module 112 may not add the selected information candidate (ICⱼ) to the validated results 118.

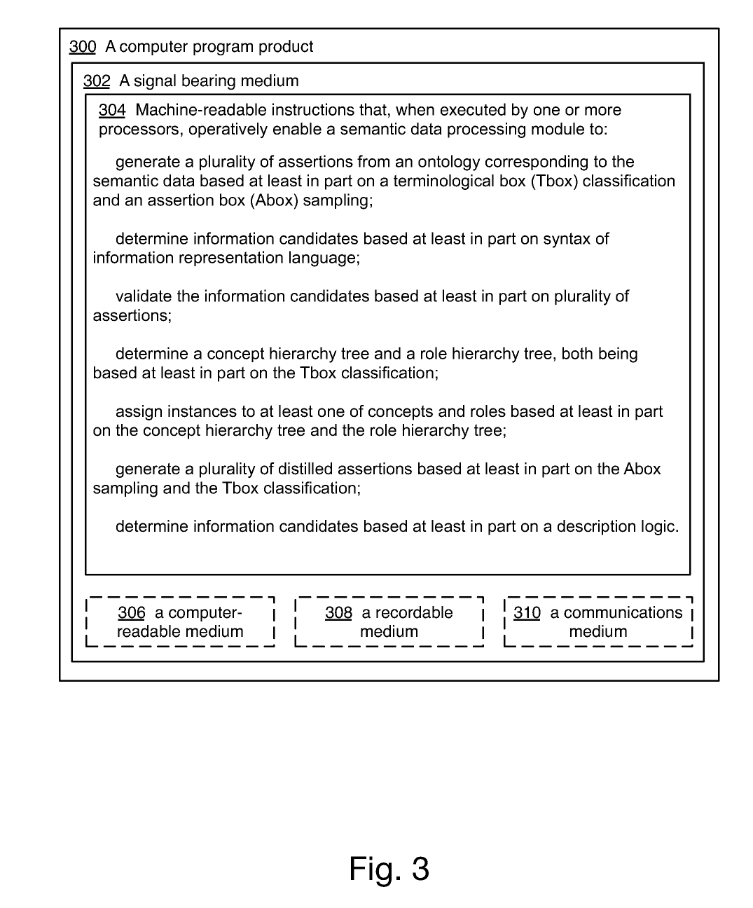

In general, the method described with respect to FIG. 2 and elsewhere herein may be implemented as a computer program product, executable on any suitable computing system, or the like. For example, a computer program product for extracting information from semantic data on the WWW may be provided. Example computer program products are described with respect to FIG. 3 and elsewhere herein.

FIG. 3 illustrates an example computer program product 300, arranged in accordance with at least some embodiments described herein. Computer program product 300 may include machine readable non-transitory medium having stored therein instructions that, when executed, cause the machine to extract information from semantic data on the WWW according to the processes and methods discussed herein. Computer program product 300 may include a signal bearing medium 302. Signal bearing medium 302 may include one or more machine-readable instructions 304, which, when executed by one or more processors, may operatively enable a computing device to provide the functionality described herein. In various examples, some or all of the machine-readable instructions may be used by the devices discussed herein.

In some examples, the machine readable instructions 304 may include generate a plurality of assertions from an ontology corresponding to the semantic data based at least in part on a terminological box (Tbox) classification and an assertion box (Abox) sampling. In some examples, the machine readable instructions 304 may include determine information candidates based at least in part on syntax of information representation language. In some examples, the machine readable instructions 304 may include validate the information candidates based at least in part on plurality of assertions. In some examples, the machine readable instructions 304 may include determine a concept hierarchy tree and a role hierarchy tree, both being based at least in part on the Tbox classification. In some examples, the machine readable instructions 304 may include assign instances to at least one of concepts and roles based at least in part on the concept hierarchy tree and the role hierarchy tree. In some examples, the machine readable instructions 304 may include generate a plurality of distilled assertions based at least in part on the Abox sampling and the Tbox classification. In some examples, the machine readable instructions 304 may include determine information candidates based at least in part on a description logic.

In some implementations, signal bearing medium 302 may encompass a computer-readable medium 306, such as, but not limited to, a hard disk drive, a Compact Disc (CD), a Digital Versatile Disk (DVD), a digital tape, memory, etc. In some implementations, the signal bearing medium 302 may encompass a recordable medium 308, such as, but not limited to, memory, read/write (R/W) CDs, R/W DVDs, etc. In some implementations, the signal bearing medium 302 may encompass a communications medium 310, such as, but not limited to, a digital and/or an analog communication medium (e.g., a fiber optic cable, a waveguide, a wired communication link, a wireless communication link, etc.). In some examples, the signal bearing medium 302 may encompass a machine readable non-transitory medium.

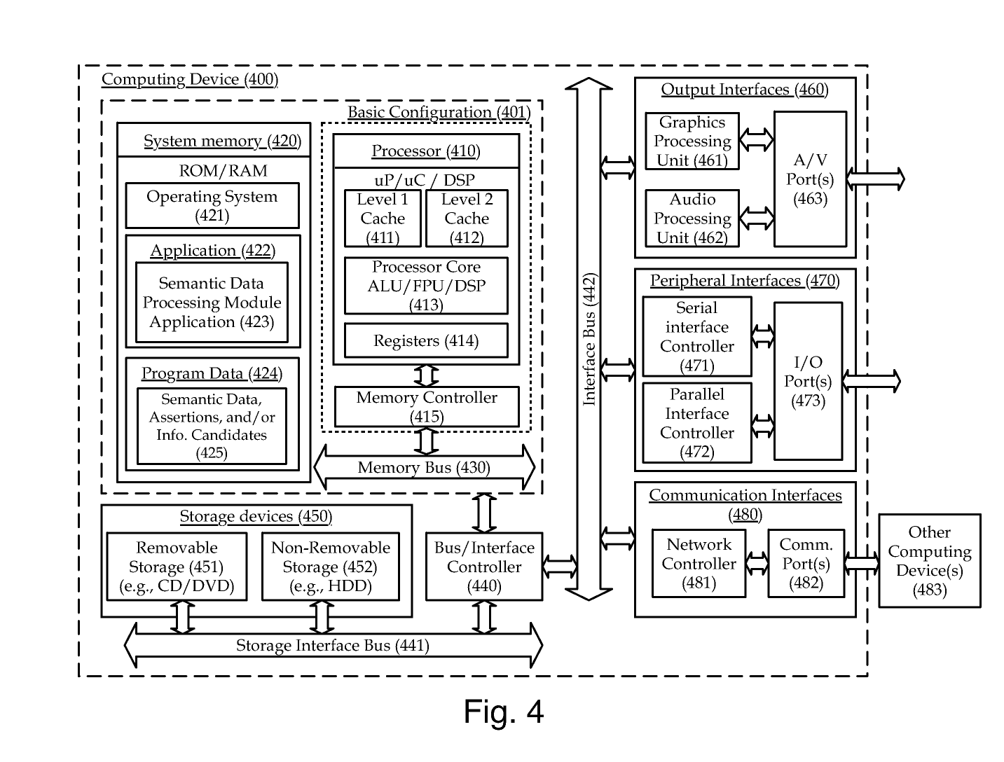

In general, the methods described with respect to FIG. 2 and elsewhere herein may be implemented in any suitable computing system. Example systems may be described with respect to FIG. 4 and elsewhere herein. In general, the system may be configured to extract information from semantic data on the WWW.

FIG. 4 illustrates a block diagram illustrating an example computing device 400, arranged in accordance with at least some embodiments described herein. In various examples, computing device 400 may be configured to extract information from semantic data on the WWW as discussed herein. In one example of a basic configuration 401, computing device 400 may include one or more processors 410 and a system memory 420. A memory bus 430 can be used for communicating between the one or more processors 410 and the system memory 420.

Depending on the desired configuration, the one or more processors 410 may be of any type including but not limited to a microprocessor (μP), a microcontroller (μC), a digital signal processor (DSP), or any combination thereof. The one or more processors 410 may include one or more levels of caching, such as a level one cache 411 and a level two cache 412, a processor core 413, and registers 414. The processor core 413 can include an arithmetic logic unit (ALU), a floating point unit (FPU), a digital signal processing core (DSP Core), or any combination thereof. A memory controller 415 can also be used with the one or more processors 410, or in some implementations the memory controller 415 can be an internal part of the processor 410.

Depending on the desired configuration, the system memory 420 may be of any type including but not limited to volatile memory (such as RAM), non-volatile memory (such as ROM, flash memory, etc.) or any combination thereof. The system memory 420 may include an operating system 421, one or more applications 422, and program data 424. The one or more applications 422 may include semantic data processing module application 423 that can be arranged to perform the functions, actions, and/or operations as described herein including the functional blocks, actions, and/or operations described herein. The program data 424 may include semantic data, assertion data, and/or information candidate data 425 for use with the network congestion module application 423. In some example embodiments, the one or more applications 422 may be arranged to operate with the program data 424 on the operating system 421. This described basic configuration 401 is illustrated in FIG. 4 by those components within dashed line.

Computing device 400 may have additional features or functionality, and additional interfaces to facilitate communications between the basic configuration 401 and any required devices and interfaces. For example, a bus/interface controller 440 may be used to facilitate communications between the basic configuration 401 and one or more data storage devices 450 via a storage interface bus 441. The one or more data storage devices 450 may be removable storage devices 451, non-removable storage devices 452, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 420, the removable storage 451 and the non-removable storage 452 are all examples of computer storage media. The computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by the computing device 400. Any such computer storage media may be part of the computing device 400.

The computing device 400 may also include an interface bus 442 for facilitating communication from various interface devices (e.g., output interfaces, peripheral interfaces, and communication interfaces) to the basic configuration 401 via the bus/interface controller 440. Example output interfaces 460 may include a graphics processing unit 461 and an audio processing unit 462, which may be configured to communicate to various external devices such as a display or speakers via one or more NV ports 463. Example peripheral interfaces 470 may include a serial interface controller 471 or a parallel interface controller 472, which may be configured to communicate with external devices such as input devices (e.g., keyboard, mouse, pen, voice input device, touch input device, etc.) or other peripheral devices (e.g., printer, scanner, etc.) via one or more I/O ports 473. An example communication interface 480 includes a network controller 481, which may be arranged to facilitate communications with one or more other computing devices 483 over a network communication via one or more communication ports 482. A communication connection is one example of a communication media. The communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR) and other wireless media. The term computer readable media as used herein may include both storage media and communication media.

The computing device 400 may be implemented as a portion of a small-form factor portable (or mobile) electronic device such as a cell phone, a mobile phone, a tablet device, a laptop computer, a personal data assistant (PDA), a personal media player device, a wireless web-watch device, a personal headset device, an application specific device, or a hybrid device that includes any of the above functions. The computing device 400 may also be implemented as a personal computer including both laptop computer and non-laptop computer configurations. In addition, the computing device 400 may be implemented as part of a wireless base station or other wireless system or device.

Some portions of the foregoing detailed description are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is here, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing device, that manipulates or transforms data represented as physical electronic or magnetic quantities within memories, registers, or other information storage devices, transmission devices, or display devices of the computing device.

The claimed subject matter is not limited in scope to the particular implementations described herein. For example, some implementations may be in hardware, such as employed to operate on a device or combination of devices, for example, whereas other implementations may be in software and/or firmware. Likewise, although claimed subject matter is not limited in scope in this respect, some implementations may include one or more articles, such as a signal bearing medium, a storage medium and/or storage media. This storage media, such as CD-ROMs, computer disks, flash memory, or the like, for example, may have instructions stored thereon, that, when executed by a computing device, such as a computing system, computing platform, or other system, for example, may result in execution of a processor in accordance with the claimed subject matter, such as one of the implementations previously described, for example. As one possibility, a computing device may include one or more processing units or processors, one or more input/output devices, such as a display, a keyboard and/or a mouse, and one or more memories, such as static random access memory, dynamic random access memory, flash memory, and/or a hard drive.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be affected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a flexible disk, a hard disk drive (HDD), a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to subject matter containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Reference in the specification to “an implementation,” “one implementation,” “some implementations,” or “other implementations” may mean that a particular feature, structure, or characteristic described in connection with one or more implementations may be included in at least some implementations, but not necessarily in all implementations. The various appearances of “an implementation,” “one implementation,” or “some implementations” in the preceding description are not necessarily all referring to the same implementations.

While certain exemplary techniques have been described and shown herein using various methods and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A method to extract information from semantic data on the world wide web, the method comprising:
generating a plurality of assertions from an ontology corresponding to the semantic data based at least in part on a plurality of statements of the ontology;
determining information candidates based at least in part on syntax of information representation language; and
validating the information candidates based at least in part on the plurality of assertions.

2. The method of claim 1, wherein generating the plurality of assertions comprises generating one or more assertions based at least in part upon a terminological box (Tbox) classification and an assertion box (Abox) sampling.

3. The method of claim 2, wherein generating the plurality of assertions comprises determining a concept hierarchy tree and a role hierarchy tree, both being based at least in part on the Tbox classification.

4. The method of claim 2, wherein generating the plurality of assertions comprises determining an assertion pattern based at least in part on the Abox sampling.

5. The method of claim 4, wherein determining the assertion pattern comprises generating a plurality of distilled assertions based at least in part on the Abox sampling and the Tbox classification.

6. The method of claim 1, wherein determining information candidates comprises determining information candidates based at least in part on a description logic.

7. The method of claim 6, wherein determining information candidates based at least in part on the description logic comprises determining information candidates based at least in part on Web Ontology Language (OWL).

8. The method of claim 1, wherein determining information candidates comprises determining information candidates based at least in part on syntax of information representation language and signatures included in the Tbox classification.

9. The method of claim 1, wherein determining information candidates comprises determining information candidates based at least in part on novelty rule.

10. The method of claim 1, wherein determining information candidates comprises determining information candidates based at least in part on simplicity rule.

11. The method of claim 1, wherein validating the information candidates comprises determining an approximate Abox sampling.

12. The method of claim 1, wherein validating the information candidates comprises calculating a certainty level for a concept candidate based at least in part on a majority rule.

13. A machine readable non-transitory medium having stored therein instructions that, when executed by one or more processors, operatively enable a semantic data processing module to:
generate a plurality of assertions from an ontology corresponding to the semantic data based at least in part on a terminological box (Tbox) classification and an assertion box (Abox) sampling;
determine information candidates based at least in part on syntax of information representation language; and
validate the information candidates based at least in part on the plurality of assertions.

14. The machine readable non-transitory medium of claim 13, wherein the stored instructions, when executed by one or more processors, further operatively enable the semantic data processing module to determine a concept hierarchy tree and a role hierarchy tree, both being based at least in part on the Tbox classification.

15. The machine readable non-transitory medium of claim 14, wherein the stored instructions, when executed by one or more processors, further operatively enable the semantic data processing module to assign instances to at least one of concepts and roles based at least in part on the concept hierarchy tree and the role hierarchy tree.

16. The machine readable non-transitory medium of claim 13, wherein the stored instructions, when executed by one or more processors, further operatively enable the semantic data processing module to determine an assertion pattern based at least in part on the Abox sampling.

17. The machine readable non-transitory medium of claim 16, wherein the stored instructions, when executed by one or more processors, further operatively enable the semantic data processing module to generate a plurality of distilled assertions based at least in part on the Abox sampling and the Tbox classification.

18. The machine readable non-transitory medium of claim 13, wherein the stored instructions, when executed by one or more processors, further operatively enable the semantic data processing module to determine information candidates based at least in part on a description logic.

19. The machine readable non-transitory medium of claim 18, wherein the stored instructions, when executed by one or more processors, further operatively enable the semantic data processing module to determine information candidates based at least in part on Web Ontology Language (OWL).

20. The machine readable non-transitory medium of claim 13, wherein the stored instructions, when executed by one or more processors, further operatively enable the semantic data processing module to determine information candidates based at least in part on syntax of information representation language and signatures included in the Tbox classification.

21. The machine readable non-transitory medium of claim 13, wherein the stored instructions, when executed by one or more processors, further operatively enable the semantic data processing module to determine an approximate Abox sampling.

22. The machine readable non-transitory medium of claim 13, wherein the stored instructions, when executed by one or more processors, further operatively enable the semantic data processing module to calculate a certainty level for a concept candidate based at least in part on a majority rule.

23. A system to extract information from semantic data on the world wide web comprising:
a processor; and
a semantic data processing module communicatively coupled to the processor, the semantic data processing module configured to:
generate a plurality of assertions from an ontology corresponding to the semantic data based at least in part on a terminological box (Tbox) classification and an assertion box (Abox) sampling;
determine information candidates based at least in part on syntax of information representation language; and
validate the information candidates based at least in part on the plurality of assertions.

24. The system of claim 23, wherein the semantic data processing module is further configured to determine a concept hierarchy tree and a role hierarchy tree, both being based at least in part on the Tbox classification.

25. The system of claim 24, wherein the semantic data processing module is further configured to assign instances to at least one of concepts and roles based at least in part on the concept hierarchy tree and the role hierarchy tree.

26. The system of claim 23, wherein the semantic data processing module is further configured to determine an assertion pattern based at least in part on the Abox sampling.

27. The system of claim 26, wherein the semantic data processing module is further configured to generate a plurality of distilled assertions based at least in part on the Abox sampling and the Tbox classification.

28. The system of claim 23, wherein the semantic data processing module is further configured to determine information candidates based at least in part on a description logic.

29. The system of claim 28, wherein the semantic data processing module is further configured to determine information candidates based at least in part on Web Ontology Language (OWL).

30. The system of claim 23, wherein the semantic data processing module is further configured to determine information candidates based at least in part on syntax of information representation language and signatures included in the Tbox classification.

31. The system of claim 23, wherein the semantic data processing module is further configured to determine an approximate Abox sampling.

32. The system of claim 23, wherein the semantic data processing module is further configured to calculate a certainty level for a concept candidate based at least in part on a majority rule.
